(19) United States
(12) Patent Application Publication
(10) Pub. No.: US 2002/0165978 A1
(43) Pub. Date: Nov. 7, 2002

(54) Multi-service optical infiniband router

(76) Inventor: Terence Chui, Milpitas, CA (US)

Correspondence Address: TERENCE CHUI, 672 PRINCESS PLACE, MILPITAS, CA, 95035, US

(21) Appl. No.: 10/139,715

(22) Filed: May 6, 2002

Related U.S. Application Data
(60) Provisional application No. 60/289,274, filed on May 7, 2001.

(51) Int. Cl. G06F 15/16; G06F 15/173

(52) U.S. Cl. 709/238; 709/230

(57) ABSTRACT

This invention pertains a system and method for interconnecting processing module within a computer device and the input/output channels external to the computer devices. More specifically, the Multi-Service Optical InfiniBand Router (OIR) relates to the use of a device to communicate with InfiniBand devices, IP-based switching devices, IP-based routing devices, SONET Add-Drop Multiplexing devices, DWDM (Dense Wavelength Division Multiplexing) devices, Fibre Channel devices, and SCSI devices.

### RELATED APPLICATION

This application claims the benefit of U.S. Provisional Pat. App. Ser. No. 60/289,274, filed on May 7, 2001. The entire teachings of the above application are incorporated herein by reference.

### BACKGROUND

1. FIELD OF THE INVENTION

This invention pertains to a system and method for interconnecting computer devices, networking devices in the local area network, metro area network, wide-area network and system area network using a plurality of computer networking interfaces.

### BACKGROUND

2. DESCRIPTION OF PRIOR ART

FIG. 1 illustrates the Traditional System Architecture. The traditional server contains the processing modules 11, the I/O modules 12, and the other interface adapters 13. The I/O is usually based on the SCSI bus or Fibre Channel. The Host usually “owns” the storage 15, which is enclosed with the server enclosure 14. The backup traffic needs to go through the LAN to the server (before getting to another storage device). It has limited scalability (16 devices per bus).

FIG. 2 illustrates the InfiniBand System Architecture. When all the major servers joined force to define an Infinite Bandwidth I/O bus, they call it InfiniBand. The idea of the InfiniBand architecture is to decouple the Processing Module, called the Server Host 22, and the I/O Module, called the target 23. The Hosts and the Targets are connected through an external switch, called the InfiniBand Switch 22. This switch can be used to connect to multiple InfiniBand nodes, including IB host, IB target, and other IB switches. The architecture is extremely scalable.

The InfiniBand is good technology if the user does not have to connect to other nodes outside of the InfiniBand System Area Network. The InfiniBand technology has some limitations; the connection between InfiniBand nodes has to be within 100 meters. In addition, there is no specification for connecting to a network beyond the LAN. For example, there is no interoperability definition for InfiniBand to connect to a SONET network. This is what this invention will be doing. Our goal is to remove these kinds of barriers and evolve InfiniBand to become the complete System Area Network solution to the Application Service Providers, the Storage Service Providers, and the large enterprises.

FIG. 3 illustrates the Optical InfiniBand (IB) Architecture when the Optical InfiniBand Router OIR system 31 is used. With this invention, the Optical InfiniBand Router 32, the IB host 31 can connect to any IB target 34, 35 without any restrictions. The nodes can be thousands of miles away but the nodes will behave like they are connected through a standard I/O bus. This is the power of our invention and that is why this product is so valuable to target customers.

In addition to transporting InfiniBand data across Local Area Network (LAN), Metro Area Network (MAN), and Wide Area Network (WAN), it will transport storage system related data across the LAN, MAN and WAN. In prior art, SCSI and Fiber Channel technologies are being used for the Storage Area Network (SAN) transport. This invention will also transport any SAN-based frames, including SCSI and Fibre Channel, across the different networking environment.

InfiniBand structure and functions are described in the literature and is therefore not described in detail here. Among the relevant reference texts are “InfiniBand Architecture Specification, Release 1.0” (ref. 1) and “InfiniBand Technology Prototypes White Paper” (ref. 15).

Fibre Channel structure and functions are described in the literature and is therefore not described in detail here. Among the relevant reference texts are “The Fibre Channel Consultant-A Comprehensive Introduction” (ref. 7) and “Fibre Channel-The Basics” (ref. 8).

Small Computer System Interface (SCSI) structure and functions are described in the literature and is therefore not described in detail here. Among the relevant reference texts are “The Book of SCSI: I/O for the New Millennium” (ref. 17) and “Making SCSI Work” (Ref. 18).

Gigabit Ethernet structure and functions are described in the literature and is therefore not described in detail here. Among the relevant reference texts are “Media Access Control (MAC) Parameters, Physical Layer, Repeater and Management Parameters for 1000 Mb/s Operation.” (Ref. 9), and “Gigabit Ethernet-Migrating to High-Bandwidth LANS” (ref. 8).

SONET structure and functions are described in the literature and is therefore not described in detail here.

Among the relevant reference texts are “American National Standard for Telecommunications-Synchronous Optical Network (SONET) Payload Mappings,” (ref. 5) and “Network Node Interface for the Synchronous Digital hierarchy (SDH) ,” (ref. 6).

Dense Wavelength Division Multiplexing (DWDM) technology is described in the literature and is therefore not described in detail here. Among the relevant reference texts are “Web ProForum tutorial:DWDM”, (ref. 13) and “Fault Detectability in DWDM Systems: Toward Higher Signal Quality & Reliability” (ref. 16).

Optical technology and Internet Protocol (IP) technologies are described in the literature and are therefore not described in detail here. Among the relevant reference texts are “The Point-to-Point Protocol (PPP)” (ref. 2), “PPP in HDLC-like Framing” (ref. 3), “PPP over SONET/SDH” (ref. 4), “Optical Communication Networks Multi-Protocol Lambda Switching:Combining MPLS Traffic Engineering Control With Optical Cross-Connects, (ref. 11), “Features and Requirements for The Optical Layer Control Plane” (ref. 12).

In conclusion, insofar as I am aware, no Optical routers or Storage Area System switches formerly developed provides the multi-services interconnection functions with InfiniBand technology. In addition, insofar as I am aware, no networking systems formerly developed provides the gateway function between the InfiniBand devices and the Storage Area Systems devices or Network Attached Storage devices.

### SUMMARY OF THE INVENTION

Objects and Advantages (over the Prior Art)

Accordingly, besides the objects and advantages of supporting multiple networking/system services described in my above patent, several objects and advantages of the present invention are:

To provide a system which can extend the transport of InfiniBand from the 100-meters limited to beyond 100 K meters

To provide a system which can transport InfiniBand data through Gigabit Ethernet interface between the InfiniBand host or target channel devices.

To provide a system which can transport InfiniBand data through SONET Add-Drop Multiplexer interface between the InfiniBand host or target channel devices.

To provide a system which can transport InfiniBand data through DWDM interface between the InfiniBand host or target channel devices.

To provide a system which can provide a gateway function, which can convert InfiniBand data stream to/from Fibre Channel data stream.

To provide a system which can provide a gateway function, which can transport InfiniBand data stream to/from Network Attached Storage Filer devices.

To provide a system which can provide Quality of Service control over the InfiniBand data stream through the OIR network. The OIR network can be comprised of Gigabit Ethernet interface, SONET interfaces, Fibre Channel interfaces and DWDM interfaces.

Further objects and advantages are to provide a highly reliable, highly available, and highly scalable system, which can be upgradeable to different transport services, including Gigabit Ethernet, SONET, and DWDM. The system is simple to use and inexpensive to manufacture compare to the current Gigabit Ethernet based IP routers, SONET Add-Drop Multiplexers, and DWDM devices. Still further objects and advantages will become apparent from a consideration of the ensuing description and drawings.

### Objects (Benefits) to our Customers

This invention provides our customers with the needed performance and the benefits as follows:

Simplification

This invention combines the capability of the InfiniBand, Gigabit Ethernet, SONET, and DWDM into one power router. By providing the multi-services, the customers can easily upgrade and modify the system/network infrastructure without major installation delay or training requirements.

Providers can greatly simplify service delivery by bringing InfiniBand, Gigabit Ethernet, SONET, DWDM service directly to every midsize to large enterprise and major application service provider (ASP)/Web hosting center.

Reliability

The OIR provides redundant hardware platform and traffic paths. By using SONET Automatic Protection Systems or DWDM optical redundant path protection methods, the OIR network is guaranteed to recover from any line/path or hardware failure within 50 milliseconds. The fast failure recovery capability is the key advantage that OIR has over the existing Ethernet based networks.

Quality of Service (QoS) support

The customers can configure the user traffic based on their needs. Policy-based Network Management provided with the OIR can manage traffic to each user connection (micro-flows). The OIR supports policies to define deterministic, guaranteed, assured, and shared traffic.

Scalable Performance

The OIR can be scaled up using interchangeable line cards. To complement the existing infrastructure, the LAN/SAN/NAS services can be connected to the OIR. Multi-service traffic can be aggregated into high speed Gigabit Ethernet (3 Gbps to 10 Gbps), SONET (2.5 Gbps to 10 Gbps), or multiple wavelength DWDM (up a multitude of gigabits per second) systems.

### BRIEF DESCRIPTION OF THE DRAWINGS

FIG. 1. is a block diagram illustrating a traditional server system architecture.

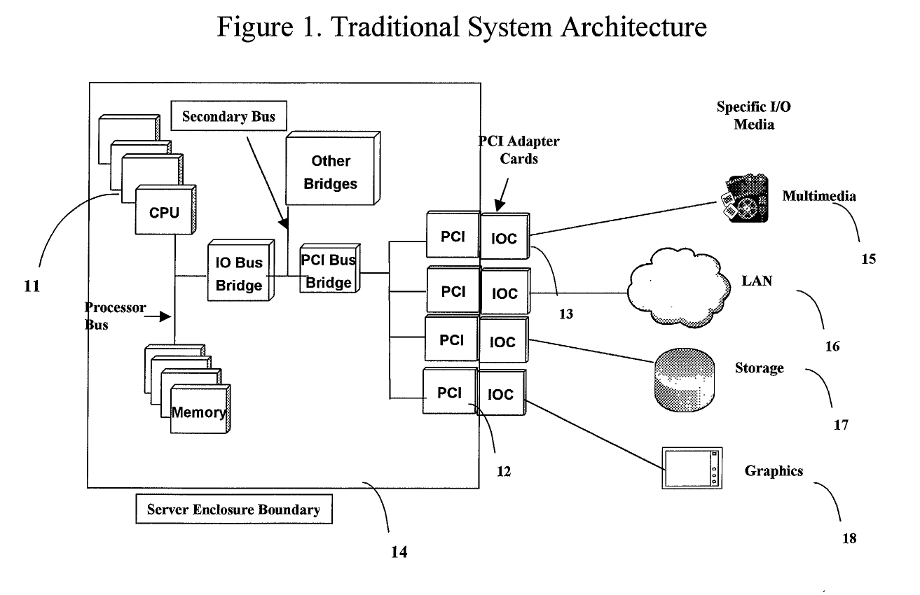

FIG. 2. is a block diagram illustrating the InfiniBand Architecture.

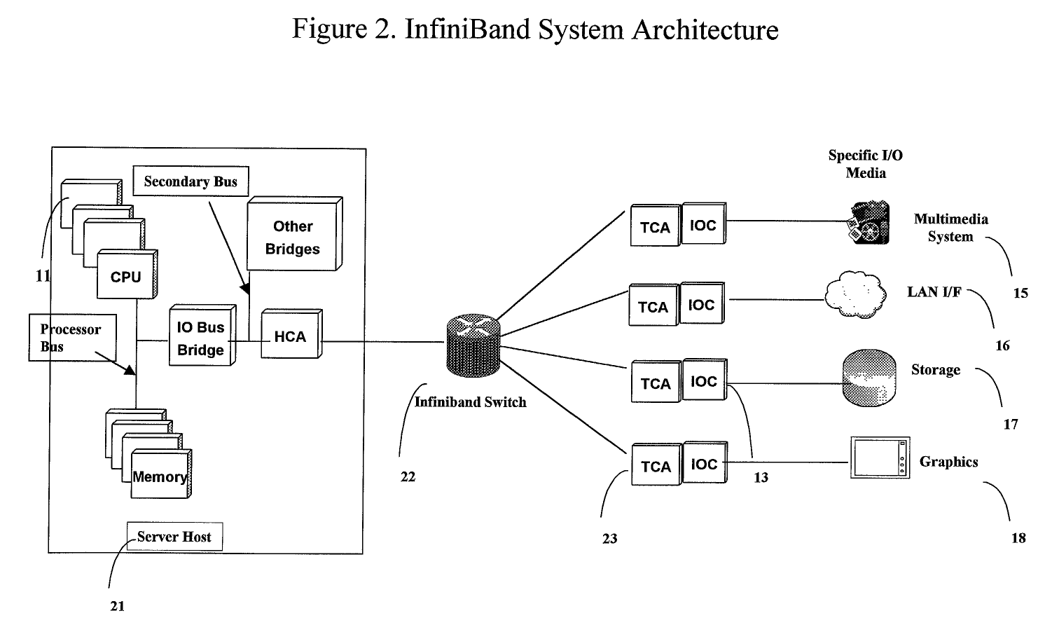

FIG. 3. is a block diagram illustrating the Optical InfiniBand Routing (OIR) system.

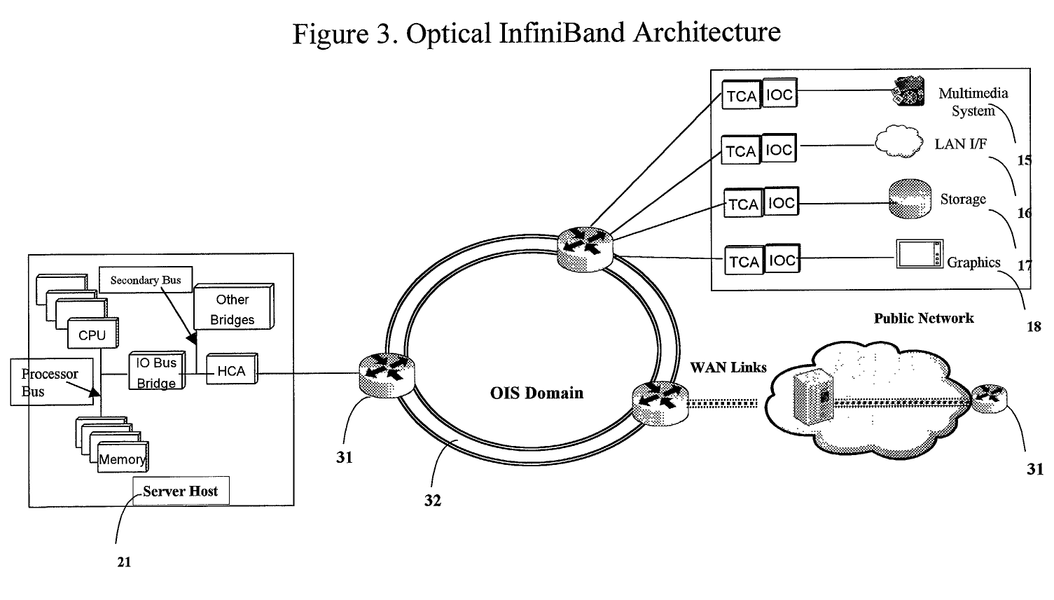

FIG. 4. is a block diagram illustrating an OIR sample system layout.

FIG. 5. is a block diagram illustrating the OIR Logical Multi-Services System Layout.

FIG. 6. is a block diagram illustrating a method for inter-networking System Area Network (SAN) switching using OIR technology.

FIG. 7. is a block diagram illustrating a method for InfiniBand Packet switching through the OIR system.

FIG. 8. is a block diagram illustrating a method for Inter-OIR InfiniBand Packet switching using Gigabit Ethernet Interfaces.

FIG. 9. is a block diagram illustrating a method for Inter-OIR InfiniBand Packet switching using SONET Interfaces.

FIG. 10. is a block diagram illustrating a method for Inter-OIR InfiniBand Packet switching using DWDM Interfaces.

FIG. 11. is a block diagram illustrating a method for Inter-OIR Fibre Channel Data switching using DWDM Interfaces.

FIG. 12. is a block diagram illustrating a method for Inter-OIR InfiniBand/Fibre Channel Data switching using DWDM Interfaces.

FIG. 13. is a block diagram illustrating a method for Inter-OIR InfiniBand/iSCSI Data switching using DWDM Interfaces.

FIG. 14. is a block diagram illustrating Packet Format for the OIR system.

FIG. 15. is a block diagram illustrating the InfiniBand Frame encapsulated within the OIR Packet.

FIG. 16. is a block diagram illustrating the Fibre Channel Frame encapsulated within the OIR Packet.

FIG. 17. is a block diagram illustrating the Ethernet Frame encapsulated within the OIR Packet.

FIG. 18. is a block diagram illustrating the iSCSI Frame encapsulated within the OIR Packet.

FIG. 19. is a block diagram illustrating the InfiniBand Ingress Processing

FIG 20. is a block diagram illustrating the InfiniBand Egress Processing

FIG 21. is a block diagram illustrating the Gigabit Ethernet Ingress Processing

FIG 22. is a block diagram illustrating the Gigabit Ethernet Egress Processing

FIG 23. is a block diagram illustrating the Fibre Channel Ingress Processing

FIG 24. is a block diagram illustrating the Fibre Channel Egress Processing

FIG 25. is a block diagram illustrating the Generic Ingress Processing for OC-48 SONET interface, OC-192 SONET interface, DWDM interface, and 10-Gigabit Ethernet interface.

FIG 26. is a block diagram illustrating the Generic Egress Processing for OC-48 SONET interface, OC-192 SONET interface.

### Reference Numerals In Drawings

11 Processing Module

12 PCI Bus Interface

13 Input/Output Controller

14 Traditional Server (Enclosure)

15 MultiMedia Device

16 Local Area Network

17 Storage (Disks, Tapes, Flash Memory)

18 Graphics Device

21 InfiniBand Server Host

22 InfiniBand Switch

23 InfiniBand Target Channel Adapter

31 Optical InfiniBand Router (OIR System)

31a Originating OIR System (same as 31-OIR system with infiniBand interface support)

31b Intermediate OIR System (same as 31-OIR system with Gigabit Ethernet interface support)

31c Originating OIR System (same as 31-OIR system with SONET interface support)

31d Destined OIR System (same as 31-OIR system with DWDM interface support)

32 2 Fiber/4 Fiber SONET/DWDM Ring Network

41 Management Card (Active/Standby)

42 InfiniBand Interface Card

43 DWDM Interface Card

44 OC-48 SONET Card

45 OC-192 SONET Card

46 10-Gigabit Ethernet Card

47 Ether-Channel Interface Card (1-Gigabit Ethernet Interface Card)

48 Fiber Channel Interface Card

49 Switching Fabric Card (Active/Standby)

51 Gigabit Ether-Channel Processing System

52 10-Gigabit Ethernet Processing System

53 OC-48 SONET Processing System

54 DWDM Processing System

55 InfiniBand Processing System

56 Fibre Channel Processing System

57 OC-192 SONET Processing System

58 Management Processing System

59 Switching Processing System

61a Client Applications/ Upper Level Protocols

61b InfiniBand Operations/ Transport Layer

61c Network Layer

61d Link Encoding within Link Layer

61e Media Access Control within Link Layer

61f Optics Fiber(O)/ Physical Layer

62a InfiniBand Device/End Node

62b FibreChannel Device/End Node

62c iSCSI Device/End Node

63 InfiniBand Interface on OIR System

64 Gigabit Ether-Channel Interface on OIR System

65 SONET Interface on OIR System

66 10-Gigabit Ethernet Interface on OIR System

67 DWDM Interface on OIR System

68 Fibre Channel Interface OIR System

69 Switching Processing System on OIR System (performing packet relay)

111a Generic Client Applications/ Upper Level Protocols

111b Fibre Channel Link Encapsulation

111c Fibre Channel Common Services

111d Fibre Channel Exchange and Sequence Management

111e Fibre Channel 8b/10b Encode/Decode and Link Control

111f Fibre Channel Optics Fiber(O)/ Physical Layer

121 InfiniBand/Fibre Channel Gateway

131 InfiniBand/iSCSI Gateway

132a iSCSI Operation

132b Ethernet Link Encoding

132c Ethernet Media Access Control

132d Ethernet Optics Fiber(O)/ Physical Layer

140 OIR System Point-to-Point Format

141 Frame Start Flag Field within OIR Point-to-Point Frame

142 Address Field within OIR Point-to-Point Frame

143 Control Field within OIR Point-to-Point Frame

144 Protocol Identifier Field within OIR Point-to-Point Fame

145 Label Field within OIR Point-to-Point Frame

146 Information Field within OIR Point-to-Point Frame (Data Payload)

147 Frame Check Sequence Field within OIR Point-to-Point Frame

148 Frame End Flag Field within OIR Point-to-Point Frame

150 InfiniBand Frame Format

150a Routing Header Field within InfiniBand Frame

150b Transport Header Field within InfiniBand Frame

150c Payload Field within InfiniBand Frame

150d CRC Field within InfiniBand Frame

160 Fibre Channel Frame

160a Start of Frame Field within Fibre Channel Frame

160b Fibre Channel Header Field within Fibre Channel Frame

160c Optional Header Field within Fibre Channel Frame

160d Payload Field within Fibre Channel Frame

160e CRC Field within Fibre Channel Frame

160f Start of Frame Field within Fibre Channel Frame

170 Ethernet Frame

170a Preamble Field within Ethernet Frame

170b Start Frame Delimiter (SFD) Field within Ethernet Frame

170c Destination Address (DA) Field within Ethernet Frame

170d Source Address (SA) Field within Ethernet Frame

170e Length (LEN) Field within Ethernet Frame

170f Data Field within Ethernet Frame

170g Padding Field within Ethernet Frame

170h Frame Check Sequence Field within Ethernet Frame

180 Internet Protocol Packet Format

181 Internet Protocol Header

182 SCSI Data

191-262 Labels for the Data Flow Diagrams

### DETAILED DESCRIPTION OF THE PREFERRED EMBODIMENTS

The invention, an InfiniBand Optical Router, has the capabilities to transport and route data packets to and from the following devices:

InfiniBand Host Server device

InfiniBand Target Channel device

SONET Add-Drop Multiplexing device

DWDM device

Gigabit Ethernet-based IP Switching device

Gigabit Ethernet-based IP Routing device

Fiber Channel Host Channel Adapter device

ISCSI device

### DRAWINGS

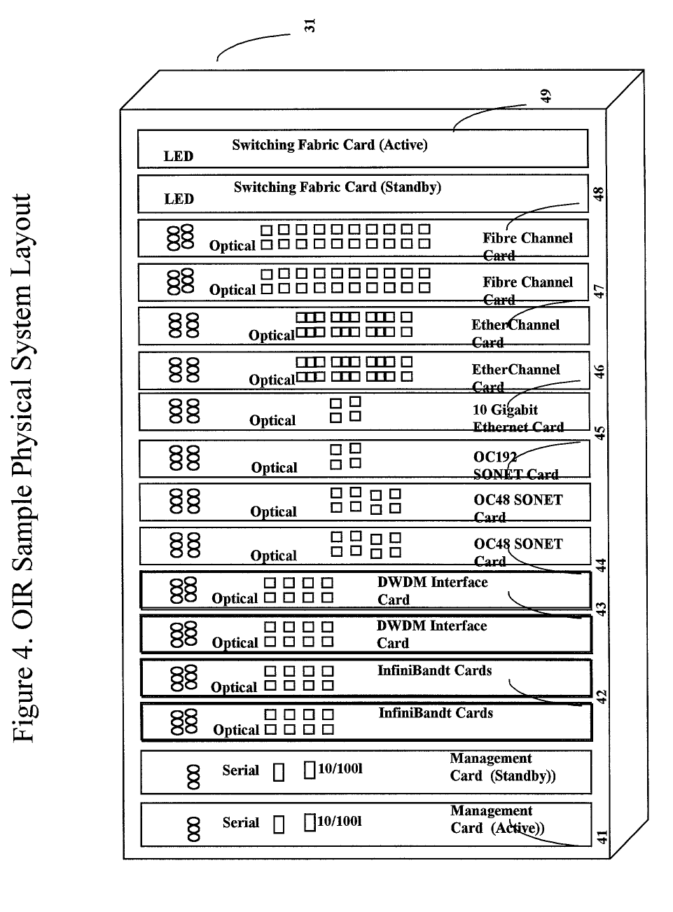

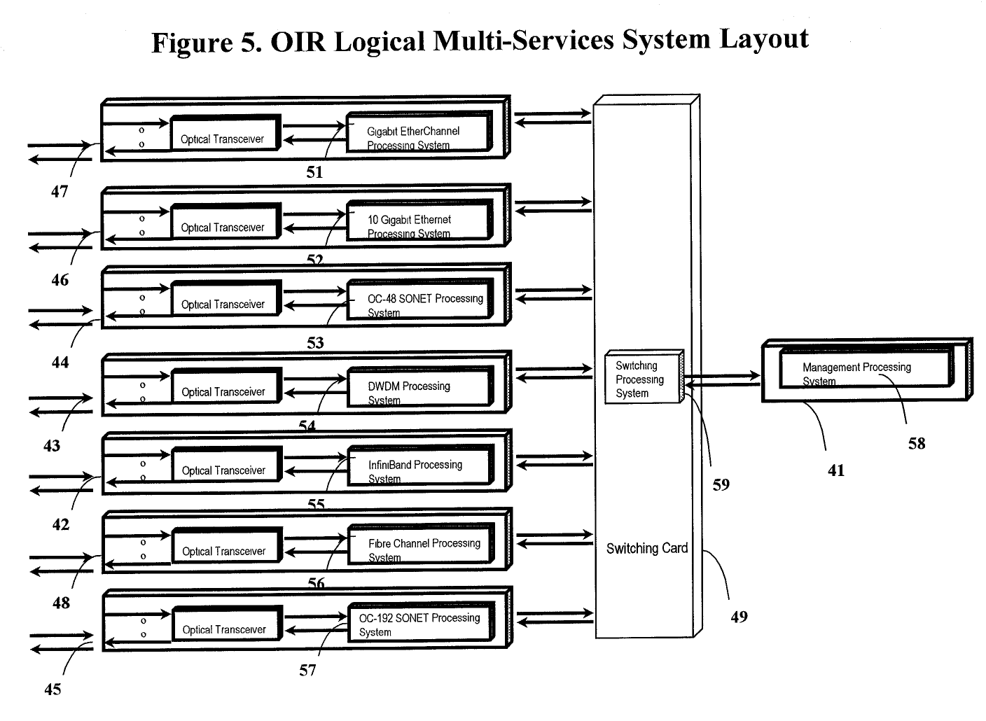

### FIGS. 4 and 5—PREFERRED EMBODIMENT

FIG. 4 illustrates a sample physical system layout and FIG. 5 illustrates the logical system layout of the Optical InfiniBand Routing (OIR) device 31. Each type of line card will contain different layer 1 and layer 2 hardware components. For example, the OC-48 SONET cards 44 will have an optical transceiver and SONET framer while the Ethernet cards 47 will have Ethernet transceivers with MAC/GMAC interface. The OIR device contains the following:

Management Card(s) 41—are responsible for the management and control of the OIR system. In addition to the OIR management functions, the Management Processing System 58 can be enhanced to perform higher-level application functions as needed.

InfiniBand Interface Card(s) 42—are responsible for interfacing with the InfiniBand Host and Target Channel devices. The InfiniBand Processing System 55 processes the InfiniBand data and encapsulates the InfiniBand payload into the OIR Point-to-Point Packet format 140.

DWDM Interface Card(s) 43—are responsible for interfacing with upstream or downstream DWDM system. The function of the DWDM Processing system 54 is mainly for multiplexing and de-multiplexing lower speed data packets onto the high-speed DWDM optical transport.

OC-48 SONET Card(s) 44—are responsible for interfacing with upstream or downstream OC-48 SONET system. The function of the SONET Processing system 53 is mainly for transporting SONET payload between SONET capable devices, including OIR system 31. Traffic from the SONET card 44 is de-multiplexed, de-framed and packet extracted before sending to the Network Processor for packet processing. The SONET Processing System 53 will perform path, line, and section overhead processing and pointer alignment processing.

OC-192 SONET Card(s) 45—are responsible for interfacing with upstream or downstream OC-192 SONET system. The function of the SONET Processing system 57 is mainly for transporting SONET payload between SONET capable devices, including OIR system 31, and multiplexing and de-multiplexing lower speed data packet onto the high-speed OC-192 SONET optical transport.

Gigabit Ether-Channel Card(s) 47—are responsible for interfacing with upstream or downstream Gigabit Ethernet system or OIR Gigabit Ether-Channel Interfaces 47. The Gigabit Ethernet card will support the GBIC interface to allow for serial data transmission over fiber optic or coaxial cable interfaces. The Gigabit Ether-Channel Processing System 51 processes the Ethernet data and encapsulates the Ethernet payload into the OIR Point-to-Point Packet format 140. It also performs fragmentation and de-fragmentation function on InfiniBand frame or other payload that has large frame size than Ethernet frame. The fragmented frames are forwarded to the destination within the OIR system 31 by a plurality of Gigabit Ethernet frames. The fragmented frames are reassembled (or de-fragmented) at the destination Gigabit Ether-Channel Interface 47 of the OIR system 31.

When InfiniBand traffic is transported through the OIR system 31 to another OIR system 31 within the OIR network, the Gigabit Ether-Channel Processing system 51 will activate the Ether-Channel processing function to transport the InfiniBand data packet using a plurality of Gigabit Ethernet channels. The Gigabit Ethernet Processing system 51 is responsible for fragmenting the InfiniBand data frame into smaller Ethernet packets and de-fragmenting the Ethernet packets into the original InfiniBand data frame.

When Fibre Channel traffic is transported through OIR system 31 to another OIR system 31 within the OIR network, the Gigabit Ether-Channel Processing system 51 will activate the Ether-Channel processing function to transport the Fibre Channel data packet using a plurality of Gigabit Ethernet channels. The Gigabit Ethernet Processing system 51 is responsible for fragmenting the Fibre Channel data frame into smaller Ethernet packets and de-fragmenting the Ethernet packets into the original Fibre Channel data frame.

When IP traffic is transported through the OIR network, no special Ether-Channel function will be used. The IP traffic will be packeted into the OIR packet format to be transported between OIR systems 31.

When iSCSI traffic is transported through the OIR network, no special Ether-Channel function will be used. The iSCSI traffic will be encapsulated within the IP payload, and then the IP payload will be packeted into the OIR packet format to be transported between OIR systems 31.

10-Gigabit Ethernet Interface Card(s) 46—are responsible for interfacing with upstream or downstream 10-Gigabit Ethernet systems. The function of the 10-Gigabit Ethernet Processing System 52 is mainly for transporting 10-Gigabit Ethernet Frames between 10-Gigabit Ethernet capable devices, including OIR system 31, and multiplexing and de-multiplexing lower speed data packets onto the high-speed 10-Gigabit Ethernet optical transport.

Fibre Channel Interface Card(s) 48—are responsible for interfacing with the Fibre Channel capable Channel devices. The Fibre Channel Processing System 56 processes the Fibre Channel data and encapsulates the Fibre Channel frames into the OIR Point-to-Point Packet Format 140.

Switching Fabric Cards(s) 49—are responsible for performing arbitration amongst packets from different input sources. Based on the Quality of Service policies, the Switching Processing System 59 will schedule the packets to be transported to different output ports of different interface cards.

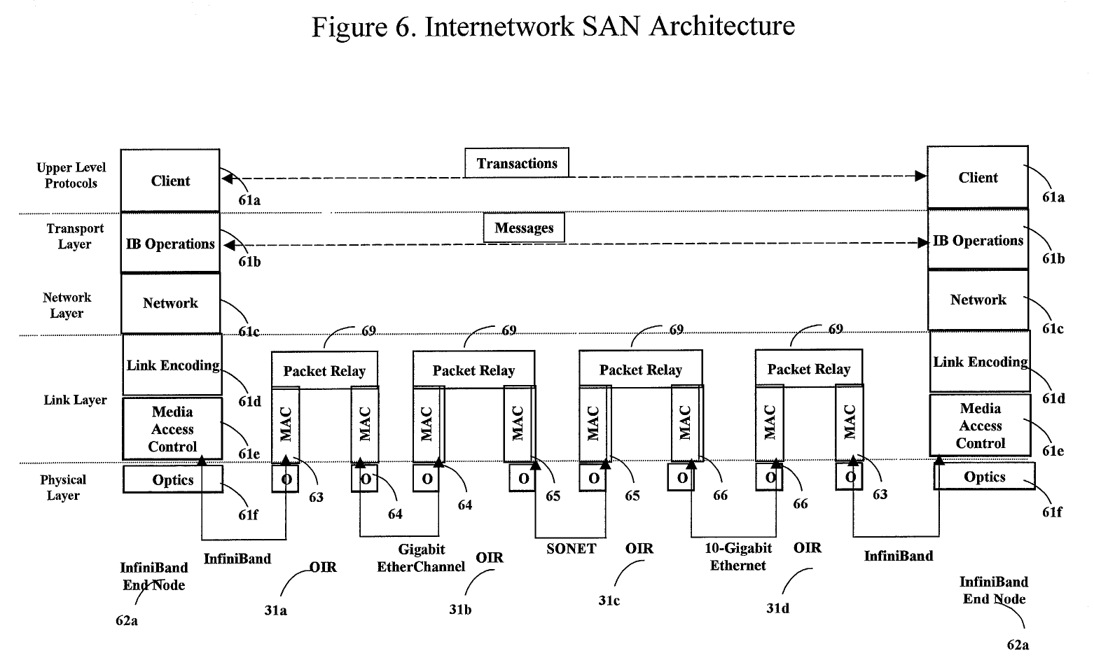

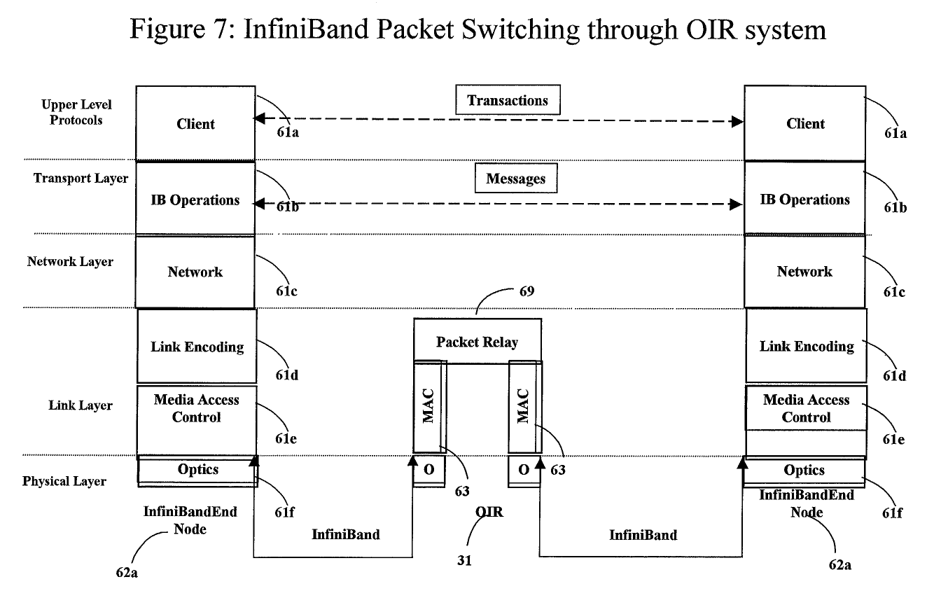

### OPERATIONS—FIGS. 6, 7,8,9,10,11,12,13

FIG. 6 is a block diagram illustrating how InfiniBand (IB) data can be transported through the OIR system 31 to other InfiniBand devices. As is known in the prior art, the Open System Interconnection (“OSI”) model is used to describe computer network. The OSI model consists of seven layers: physical, link, network, transport, session, presentation, and application. Since the OIR is a routing device that focuses on the network and link layer, the other 5 layers will not be discussed in detail.

In a normal InfiniBand operation, the client application 61a at the originating end nodes 62a invokes an IB operation 61b on an InfiniBand capable device, an InfiniBand Host Channel Adapter. The Host Channel Adapter interprets the Work Queue Elements (WQE), creates a request packet with the appropriate destination address. The destination address is composed of two unicast identifiers—a Global Identifier (GID) and Local Identifier (LID). The GID is used by the network layer 61c for routing the packets between subnets. The LID is used by the Link Layer 61d to switch packets within a subnet.

The physical layer 61f is responsible for establishing physical link and delivering received control and data bytes to the link layer 61d, 61e. The Link Layer 61d, 61e provides supports for addressing, buffering, flow control, error detection and switching. The InfiniBand request packet is sent from the originating end node 31a to the OIR InfiniBand Interface Card 42 of an OIR system 31b.

The OIR InfiniBand Processing System 55 encapsulates the InfiniBand packet into the OIR Packet payload 150c. In addition, it will generate an OIR label 145, which is used by the OIR system 31 to route the InfiniBand packet to the destination end node 31b.

In FIG. 6, the originating OIR node 31a and intermediate OIR node 31b are interfacing using Gigabit Ethernet interfaces 64. Therefore, the Gigabit Ether-Channel Processing System 51 within the OIR nodes 31a will convert the Inf iniBand packet into a plurality of smaller Ethernet frames before encapsulating it into the OIR payload. The receiving OIR node 31b will reassemble the Ethernet frames into a complete InfiniBand packet.

FIG. 6 demonstrates that when the intermediate OIR nodes 31b and 31c are using SONET interfaces 65, the InfiniBand packet will be encapsulated within an OIR payload and transported using the SONET interface 65.

Another sample transport demonstrated in FIG. 6 is the 10-Gigabit Ethernet interface 66 between the intermediate OIR nodes 31c and the destined OIR node 31d. The OIR payload, which contains the InfiniBand packet encapsulated within, will be transported directly on the 10-Gigabit Ethernet interface 66 to OIR node 31c without further processing. At the destined OIR node 31d, the InfiniBand packet will be forwarded to the destined port on the InfiniBand Interface card 42 to be transported to the InfiniBand end node 62a.

FIG. 7 illustrates the method of how the InfiniBand packets are switched using the OIR system 31.

From the InfiniBand client's 61a point of view, the InfiniBand Host Operations 61b can be performed directly on the InfiniBand Target 62a. The details of how the InfiniBand Work Requests are performed are transparent to the Client 61a. The actual operation in packet relaying is done by the OIR system 31.

From an operational point of view, the InfiniBand end nodes 62a are connected to a true InfiniBand switch as defined in the InfiniBand Architecture Specification (see reference [1]), although the OIR system 31 provides a multitude of InfiniBand ports than any existing InfiniBand switching device. The InfiniBand card 42 will detect whether the connecting InfiniBand end nodes is an InfiniBand host (through its Host Channel Adapter interface) or an InfiniBand target (through its Target Channel Adapter interface) and set up the link accordingly. The Packet relay function 69 is provided by the OIR system 31 to switch InfiniBand packets from one InfiniBand interface port 63 to another interface port 63 within the same interface card 42 or to another interface card on the same OIR system 31.

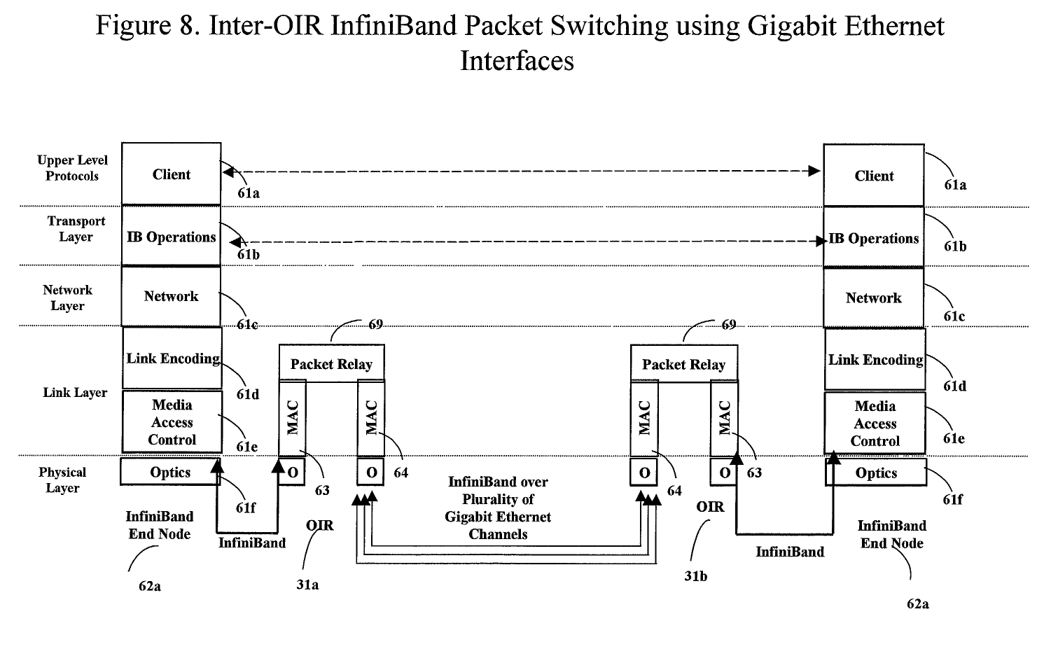

FIG. 8 illustrates the method of how the InfiniBand packets are transported through the OIR nodes 31a, 31b using the Gigabit Ether-Channel interfaces 65. The Gigabit Ether-Channel is composed of a plurality of 1-Gigabit Ethernet interfaces 65. The multiple 1-Gigabit Ethernet bandwidth is aggregated into a logical channel to support the higher bandwidth that is received from the InfiniBand interface. The fragmentation and de-fragmentation functions are performed by the Gigabit Ether-Channel processing system 51.

The InfiniBand end nodes 62a can interface to the OIR system 31a, 31b using a single InfiniBand fiber link. The OIR system 31a, 31b will in turn fragment and de-fragment the InfiniBand frames into multiple 1-Gigabit Ethernet frame before passing them between the OIR systems 31a, 31b. The assignment of the 1-Gigabit Ethernet ports to the Ether-Channel can be provisioned by the user or can be done using the default configuration.

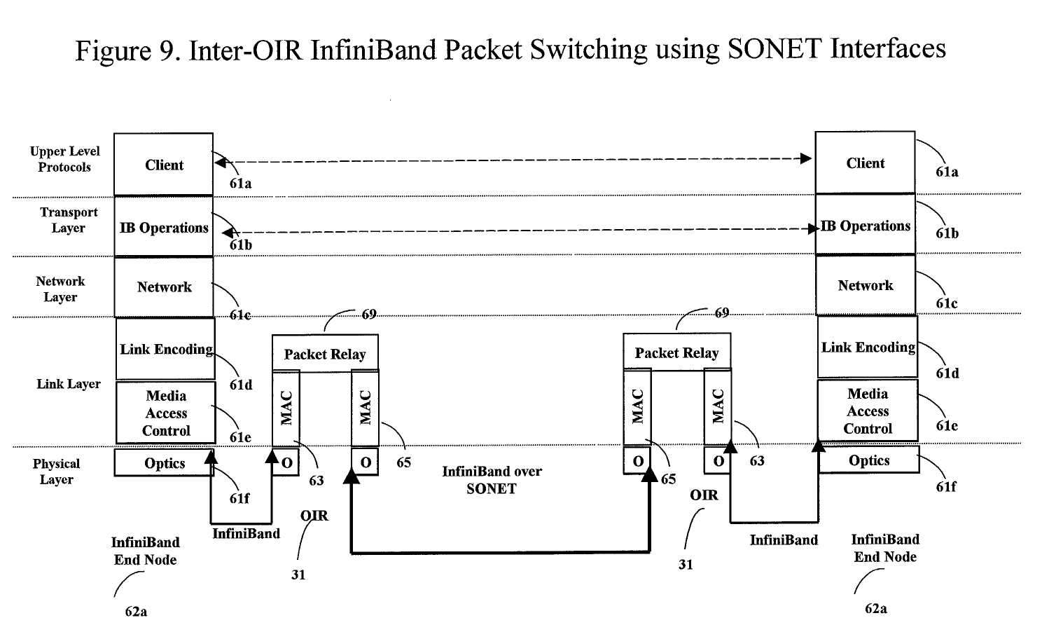

FIG. 9 illustrates the method on how the InfiniBand packets are routed through the OIR system 93,94 using the SONET interface. InfiniBand frames transported over SONET use the Point-to-Point protocol, based on IETF Packet over SONET (see reference [2], [3], and [4]). PPP protocol uses the SONET transport as a byte-oriented full-duplex synchronous link. The OIR Point-to-Point Packet 140 is mapped into the SONET Synchronous Payload Envelope (SPE) based on the payload mapping. The packet data will be aligned at the SPE octet and occupy the full forty-eight octets for the OC48c frame.

The InfiniBand end nodes 62a interface to the OIR system 31c through the InfiniBand interface. The InfiniBand frames are encapsulated into the OIR Point-to-Point packet 140. The packet is then mapped into the SONET SPE and forwarded to the destined OIR system 31c. At the destined OIR system, the OIR system will strip out the InfiniBand frames from the OIR packet before forwarding it to the InfiniBand end nodes 62a.

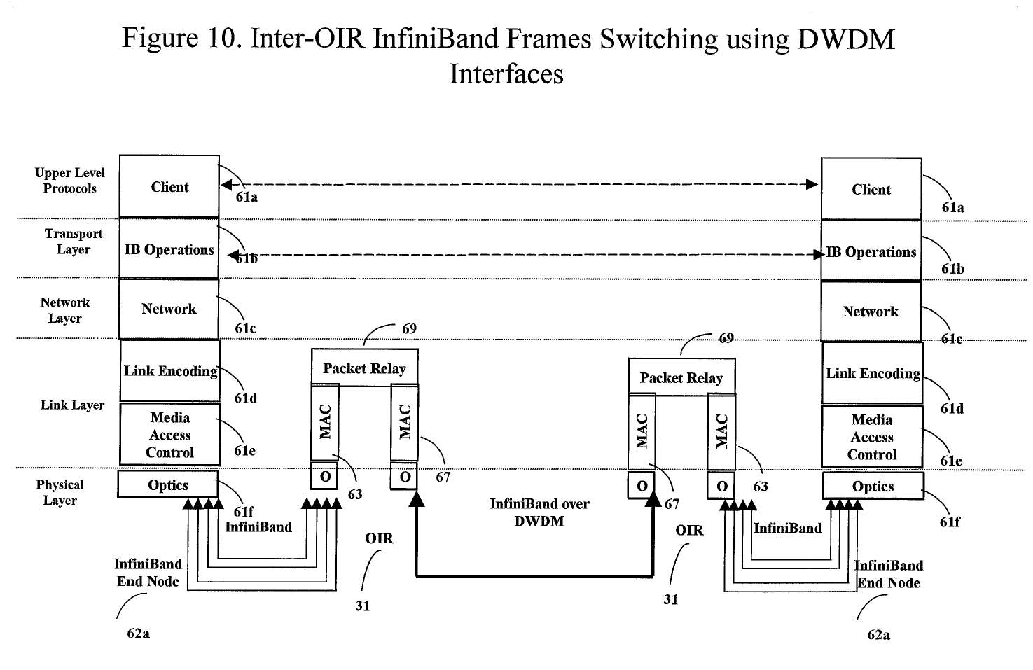

FIG. 10 illustrates the method of how the InfiniBand packets are switched using the DWDM Interfaces 67. The DWDM interface is a more effectively way of transporting data between optical system. It is a fiber-optic transmission technique that involves the process of multiplexing a multitude of wavelength signals onto a single fiber. In the OIR system 31d, each DWDM Interface card 43 can support a plurality of wavelength signals on each port. The DWDM layer within the OIR system has been designed in compliance with industry standards (see reference [13]). The bit rate and protocol transparency allows the DWDM interface to transport native enterprise data traffic like InfiniBand, Gigabit Ethernet, Fibre Channel, SONET, IP, iSCSI, etc. on different channels. It brings the flexibility to the OIR system in relation to the overall transport system; it can connect directly to any signal format without extra equipment.

The OIR system contains an optical amplifier that is fueled by a compound called Erbium, operated in a specific band of the frequency spectrum. It is optimized for interfacing with existing fiber and can carry a multitude of lightwave channels.

InfiniBand frames transported over DWDM use Point-to-Point (PPP) protocol. PPP protocol uses the DWDM transport as a byte oriented full-duplex link. The OIR system will use the lightweight SONET layer approach to transport OIR Packet over the DWDM transport. That is, the OIR system will preserve the SONET header as a means of framing the data but will not use the Time Division Multiplexing (TDM) approach to transport payload. The OIR packet is transported to the next OIR system 31d “as is”. The OIR system 31d will have the intelligence to add and drop wavelengths at the destination OIR system 31d.

Forward Error Correction (FEC) function is performed in all OIR systems 31d to provide the capability to detect signal errors. The FEC data is put into the unused portion of the SONET header. Network restoration and survivability functions will be supported by the Multiple Protocol Lambda Switching (MPLS) protocol (see reference [11]).

OIR systems 31d can interconnect to the InfiniBand end nodes 62a by establishing a light path between the two end nodes. This light path is a logical path that is established so that the optical signal can traverse the intermediate OIR system 31d to reach the destination end node from an originating end node.

The InfiniBand end nodes 62a interface to the OIR system 31d through InfiniBand interfaces 63. The InfiniBand frames are encapsulated into the OIR Point-to-Point packet 140. Based on the destination address, a route and wavelength are assigned to carry the OIR packet. The packet is then inserted into the wavelength transport and forwarded to the destination OIR system 94, 95. At the destination OIR system, the Optical-Electrical-Optical (OEO) function is performed to convert the OIR packet into machine-readable form. The OIR system 31d will then strip out the InfiniBand frames 150 from the OIR packet 140 before forwarding it to the InfiniBand end nodes 62a.

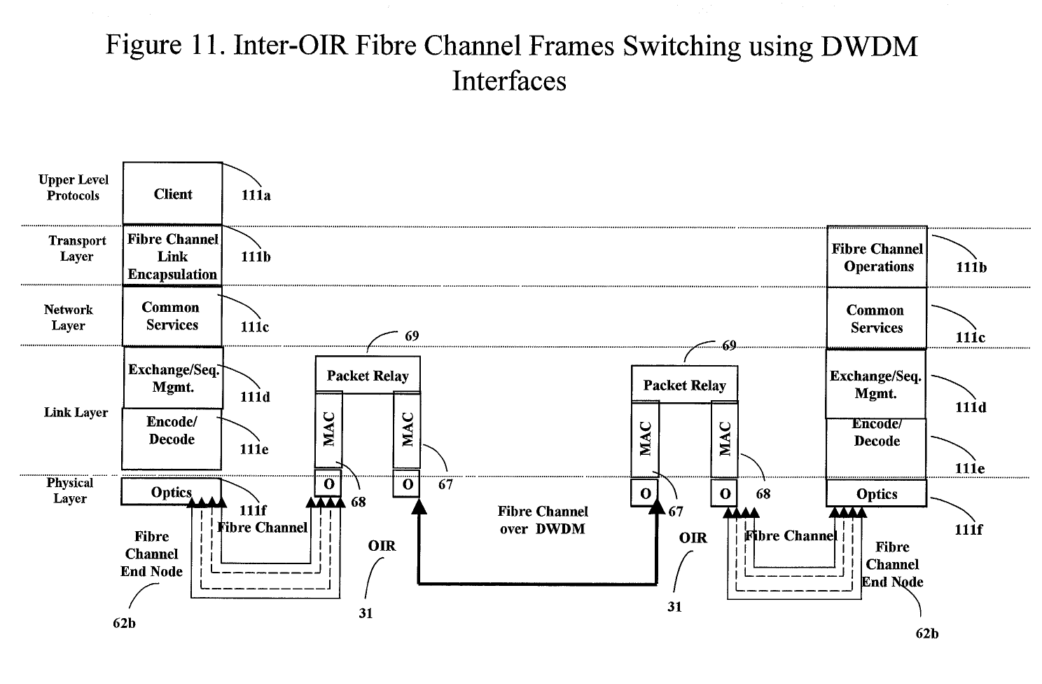

FIG. 11 illustrates the method of how the Fibre Channel Frames are switched using the DWDM Interfaces 67. The operation in transporting the Fibre Channel frames through the DWDM interface of the OIR system network is similar to what has been discussed in previous paragraphs.

The Fibre Channel end nodes 62b interface to the OIR system 31d through Fibre Channel interfaces 68. The Fibre Channel frames are encapsulated into the OIR Point-to-Point packet 140. Based on the destination address, a route and wavelength are assigned to carry the OIR packet. The packet is then inserted into the wavelength transport and forwarded to the destination OIR system 31d. At the destined OIR system 31d, the Optical-Electrical-Optical (OEO) function is performed to convert the OIR packet into machine-readable form. The OIR system will then strip out the Fibre Channel frames 160 from the OIR packet 140 before forwarding it to the Fibre Channel end nodes 62b.

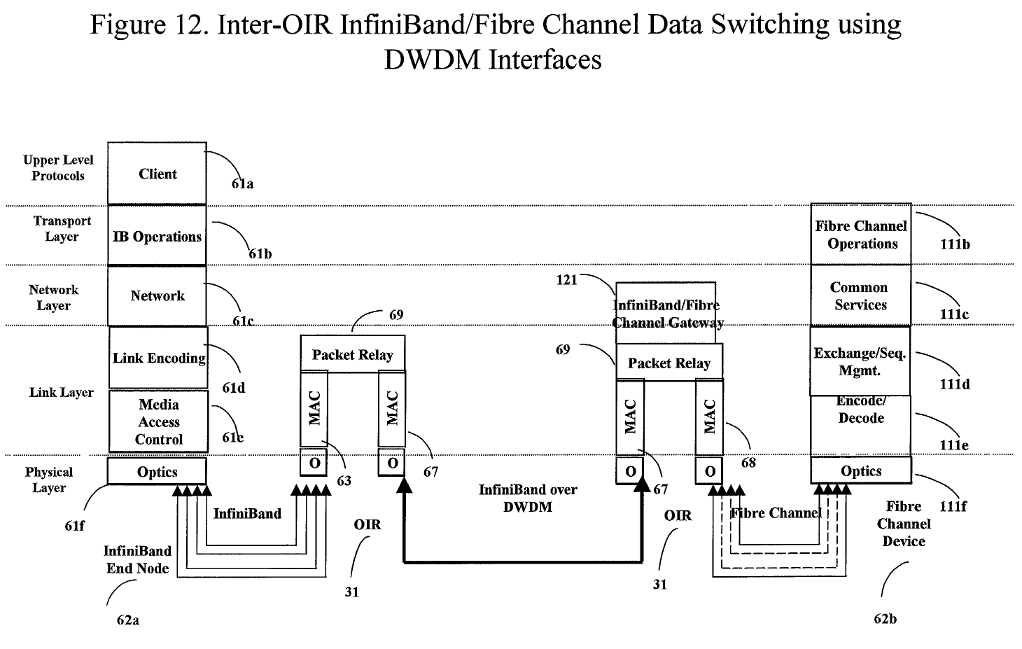

FIG. 12 illustrates the method of how the InfiniBand Host Client can interface with the Fiber Channel Target device through the OIR system InfiniBand/Fibre Channel Gateway function. The InfiniBand Frames switching between OIR system 31d is the same as described in discussion for FIG. 10. The major difference is that the destination OIR system31d will perform the InfiniBand/Fibre Channel gateway function to bridge the InfiniBand data and the Fibre Channel data.

To support the InfiniBand/Fibre Channel gateway function, the user will provision and activate the InfiniBand/Fibre Channel Gateway 121 function at the OIR system 31d. A gateway server function 121 will be started and it will also setup the link between the Fibre Channel devices that are connected to the OIR Fibre Channel Interface ports 68. The gateway server will automatically setup the links with the Fibre Channel devices.

The gateway server will also advertise itself to the other InfiniBand Subnet Management Agents (SMA) (as described in InfiniBand Architecture Specification, reference [1]) about the existence of InfiniBand target devices. The InfiniBand end node 62a, which is acting as a Host Server, will treat the Fibre Channel devices attached to the OIR system 31d as targets; it will be able to perform InfiniBand operations on them.

The InfiniBand data are carried from the Client 61a, through the intermediate OIR system 31d to the destination OIR system 31d. The InfiniBand frame data 150 is stripped from the OIR packet 140 and is forwarded to the InfiniBand/Fibre Channel gateway server 121. The gateway server 121 converts the InfiniBand data 150 into meaningful Fibre Channel commands/control information 160 and passes it down to the Fibre Channel device 62b through the destination Fibre Channel Interface port 68. The Fibre Channel device 62b that is attached to the Fibre Channel Interface port 68 will respond to the Fibre Channel commands/control information 160 as required. A similar process is performed when the Fibre Channel device 62b returns the storage data to the InfiniBand host 62a.

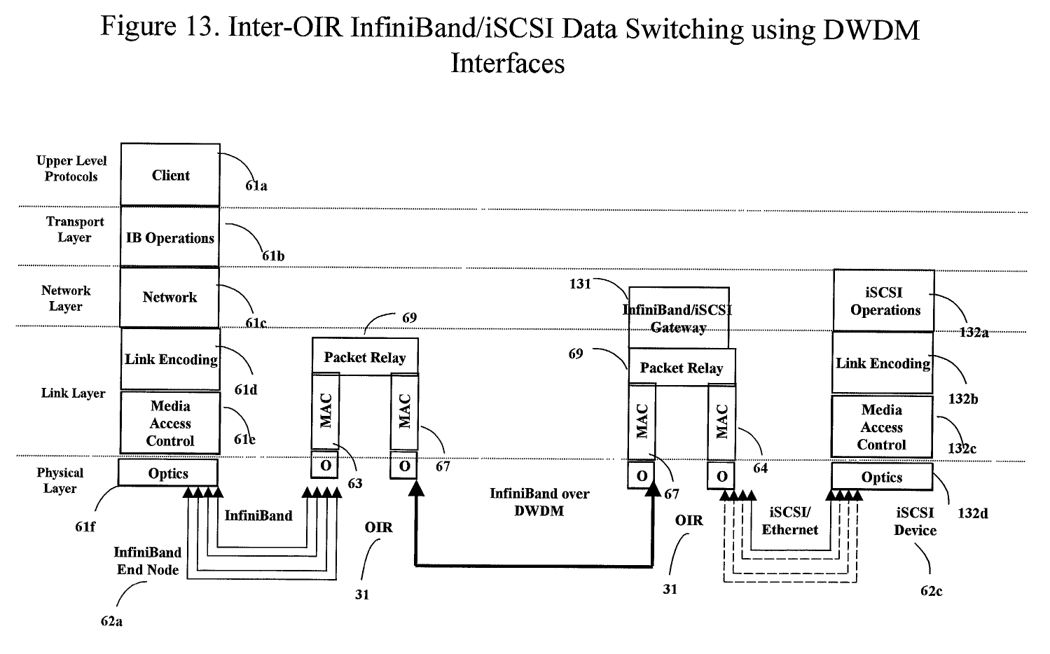

FIG. 13 illustrates the method of how the InfiniBand Host Client 61a can interface with the iSCSI Target device 62c through the OIR system InfiniBand/iSCSI Gateway function 131. The InfiniBand Frames switching between OIR systems 31d is the same as described in discussion for FIG. 10. The major difference is that the destination OIR system will perform the InfiniBand/iSCSI gateway function to bridge the InfiniBand data 150 and the iSCSI data 180.

iSCSI is a storage networking technology, which allows users to use high-speed SCSI (Small Computer Systems Interfaces) devices through out Ethernet networks. Natively, the OIR system 31d allows SCSI data to be transported through the OIR system 31 network using the Gigabit Ethernet interfaces 64. However, when InfiniBand is used from the Client 61a to access iSCSI devices 62c, the OIR system 31d can provide an additional benefit.

The benefit of using the OIR system 31 is that the Client 61a can perform the same InfiniBand operation 61b on a plurality of devices, including InfiniBand Target devices 62a, Fibre Channel devices 62b, and iSCSI devices 62c. Similar to the discussion on InfiniBand/Fibre Channel gateway operation, the InfiniBand data 150 will be converted to ISCSI command/control information 180 by the InfiniBand/iSCSI Gateway server 131. The iSCSI information 180 is forwarded by the OIR system 31d through its Gigabit Ethernet interface 64 to the iSCSI device 62c.

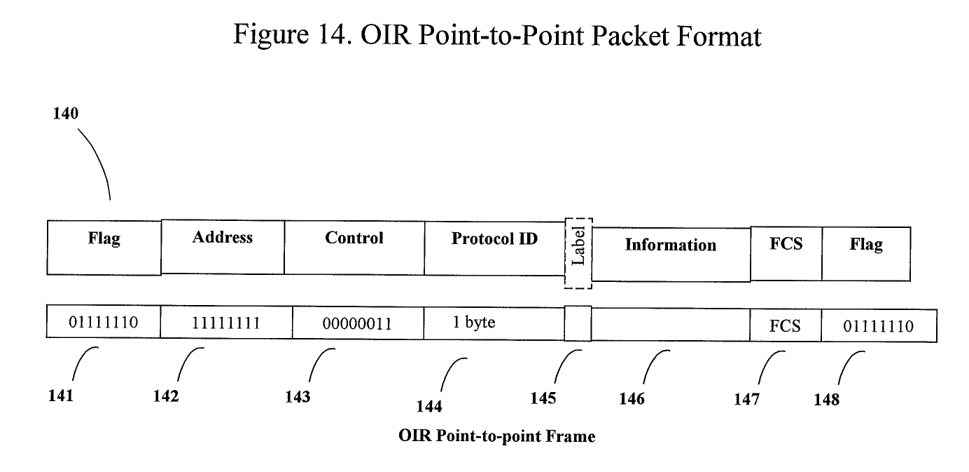

### Data Format—FIG. 14, 15, 16, 17, and 18

FIG. 14 illustrates the Optical InfiniBand Router (OIR) Point-to-Point packet format 140. The OIR packet 140 is based on a HDLC-like Point-to-Point framing format described in IETF RFC 1662 (see references [2], and [3]). The following describes the field information:

Flag 141, 148—The Flag Sequence indicates the beginning or end of a frame.

Address 142—The Address field contains the binary sequence 11111111, which indicates “all station address”. PPP does not assign individual station addresses.

Control 143—The Control field contains the binary sequence 00000011.

Protocol ID 144—The Protocol ID identifies the network-layer protocol of specific packets. The proposed value for this field for InfiniBand is 0×0042, Fibre Channel is 0×0041, and iSCSI is 0×0043. (Internet Protocol field value is 0×0021).

Label 145—The Label field supports the OIR Label switching function.

Information field 146—Data frame is inserted in the Information field with a maximum length of 64 K octets. (Note: the default length of 1,500 bytes is used for small packet).

FCS (Frame Check Sequence) field 147—A 32-bit (4 bytes) field provides the frame checking function. (Note: 32 bits instead of 16 bits is used to improve error detection.)

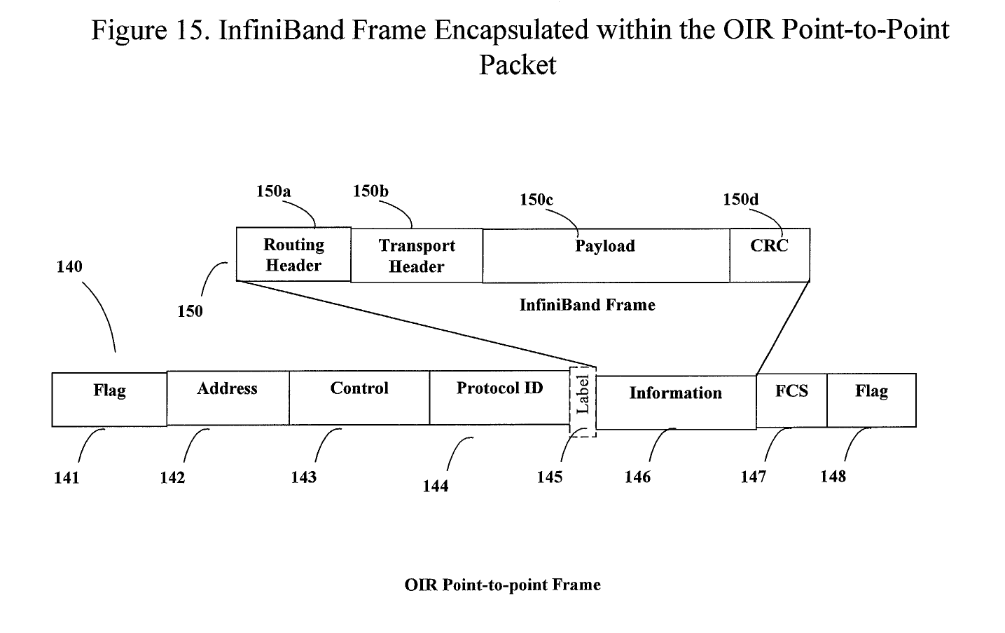

FIG. 15 illustrates the method of how an InfiniBand Frame 150 is encapsulated within the Optical InfiniBand Router (OIR) Point-to-Point packet format The following describes the field information for the InfiniBand Frame:

Routing Header 150a —contains the fields for routing the packet between subnets.

Transport Header 150b —contains the fields for InfiniBand transports.

Payload 150c —contains actual frame data.

CRC 150d —Cyclic Redundancy Check data

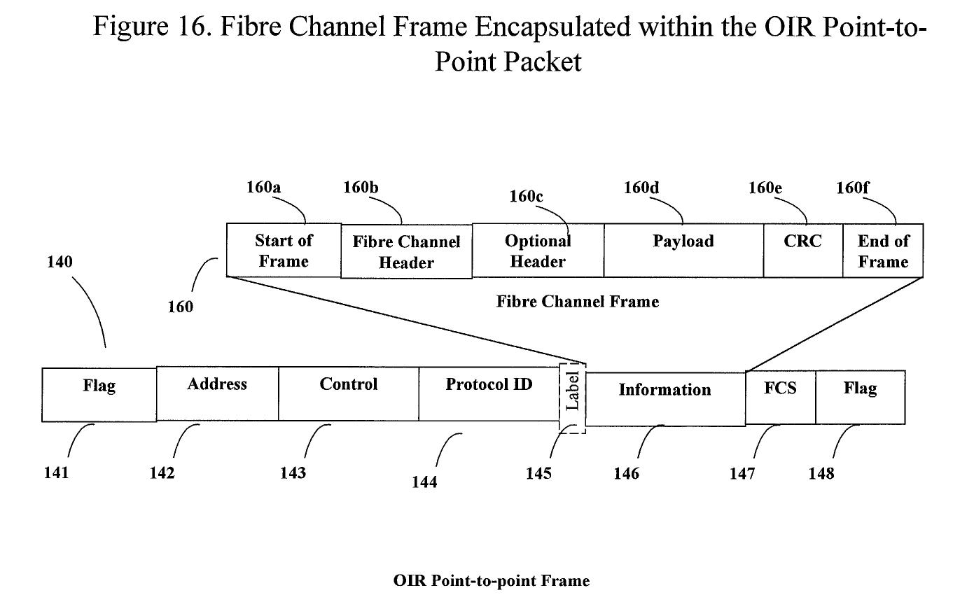

FIG. 16 illustrates the method of how a Fibre Channel Frame 160 is encapsulated within the Optical InfiniBand Router (OIR) Point-to-Point packet format 140. The following describes the field information for the Fibre Channel Frame:

Start of Frame 160a —indicates beginning of a frame.

Fibre Channel Header 160b—contains control and addressing information associated with the Fibre Channel frame .

Optional Header 160c—contains a set of architected extensions to the frame header.

Payload 160d—contains actual frame data.

CRC 160e —Cyclic Redundancy Check data

End of Frame 160f —indicates end of a frame

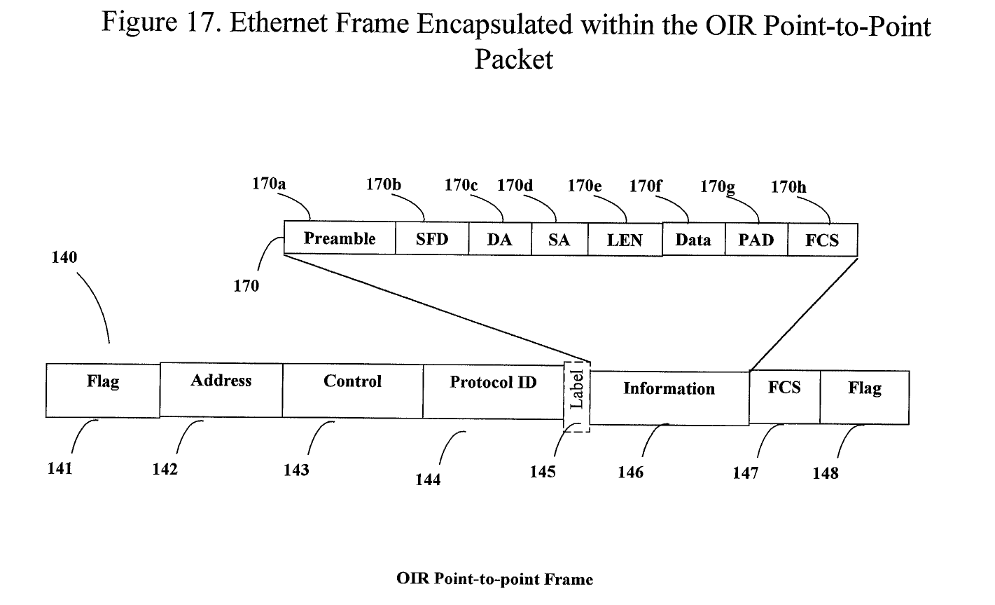

FIG. 17 illustrates the method of how an Ethernet Frame 170 is encapsulated within the Optical InfiniBand Router (OIR) Point-to-Point packet format 140. The following describes the field information for the Ethernet Frame 170:

Preamble 170a —indicates beginning of a frame. The alternating “1, 0” pattern in the preamble is used by the Manchester encoder/decoder to “lock on” to the incoming receive bit stream and allow data decoding.

Start Frame Delimiter (SFD) 170b —is defined as a byte with the “10101011” pattern.

Destination Address (DA) 170c —denotes the MAC address of the receiving node.

Source Address (SA) 170d —denotes the MAC address of the sending node.

Length (LEN) 170e —indicates the frame size.

Data 170f —contains actual frame data.

PAD 170g —contains optional padding bytes.

Frame Check Sequence (FCS) 170h —for error detection.

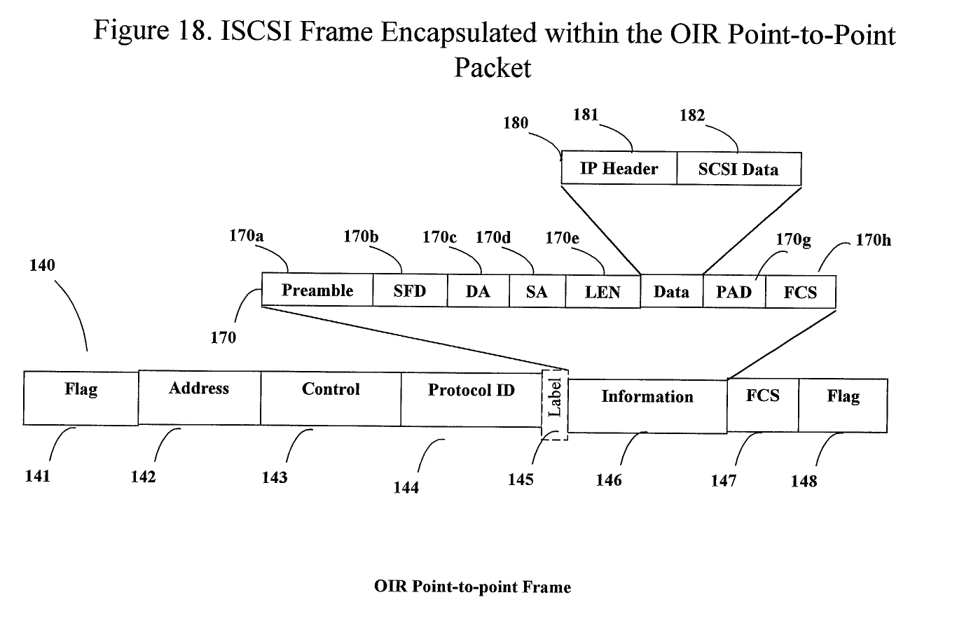

FIG. 18 illustrates the method of how iSCSI Frame 180 is encapsulated within the Optical InfiniBand Router (OIR) Point-to-Point packet format 140. The iSCSI Frame 180 is basically SCSI data encapsulated within the IP Packet, which in turn is wrapped within the Ethernet frame 170. The following describes the Internet Protocol (IP) field information:

IP Header 181—contains the Internet Protocol Header Information.

SCSI 182—contains SCSI commands.

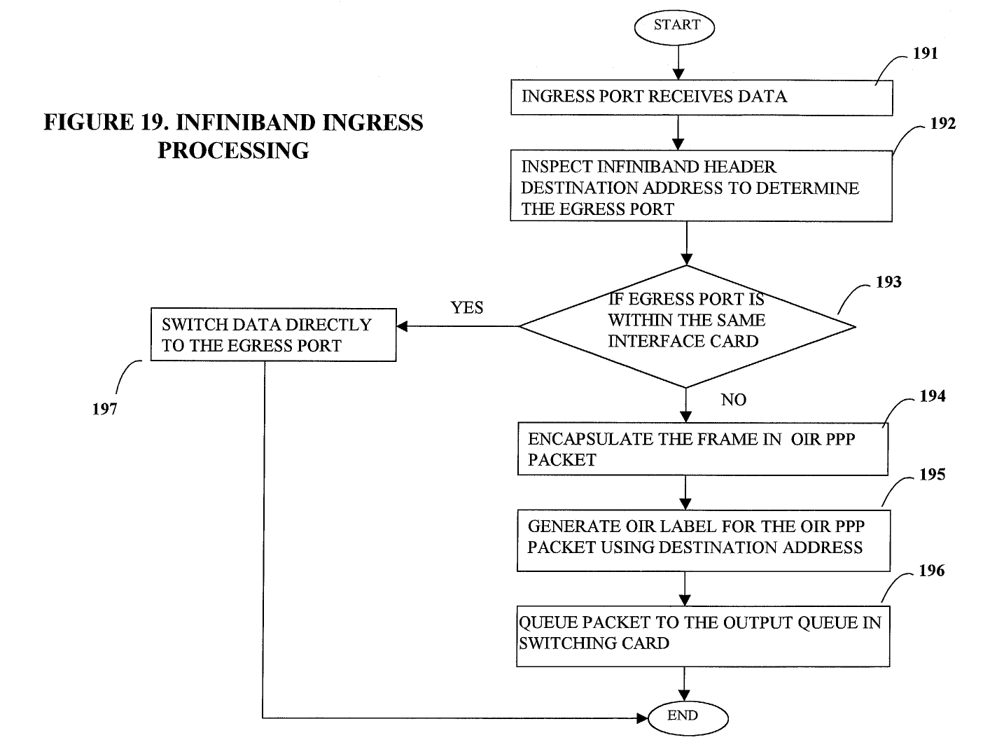

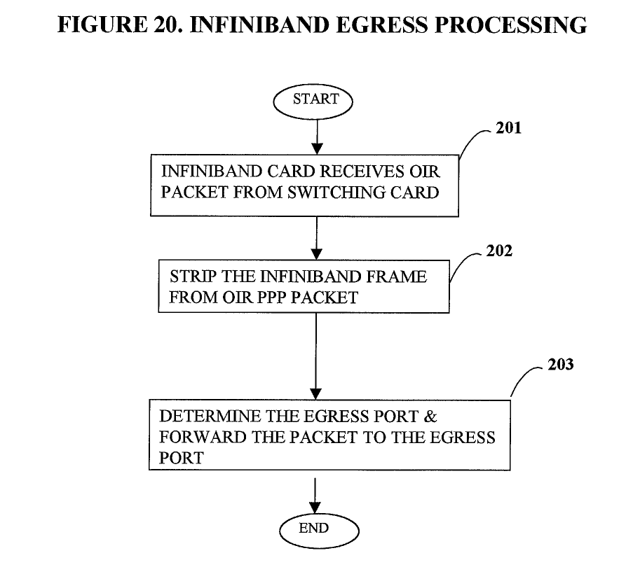

FIG. 19 illustrates the method of how InfiniBand Processing System 55 processes the input data, while FIG. 20 illustrates the method of how the said InfiniBand Processing System 55 processes the output data.

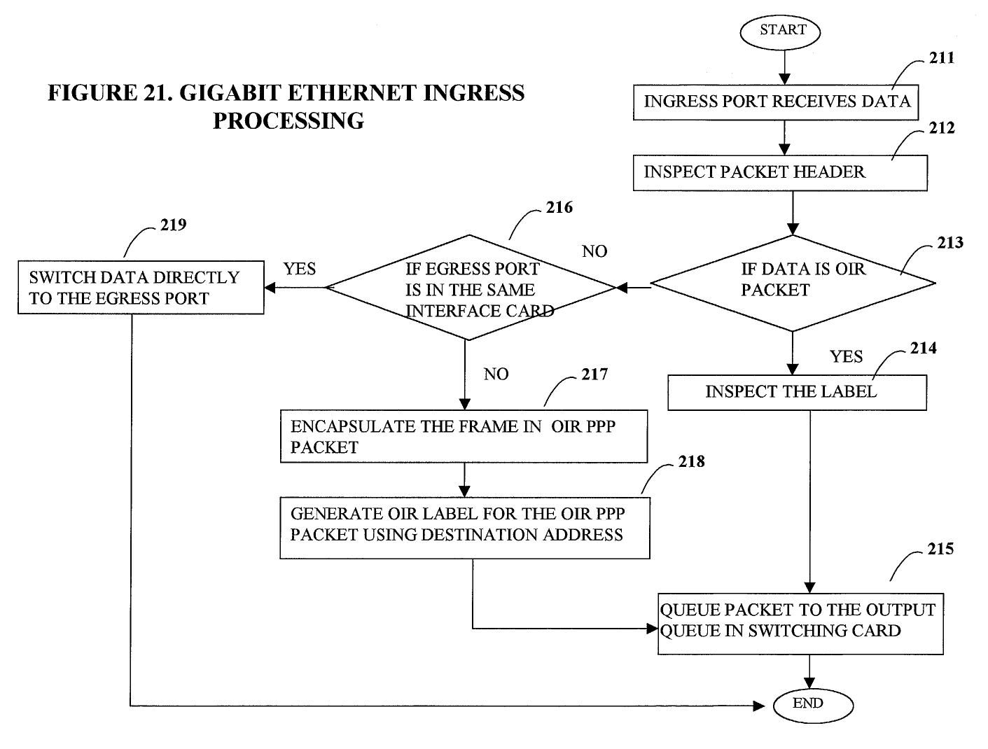

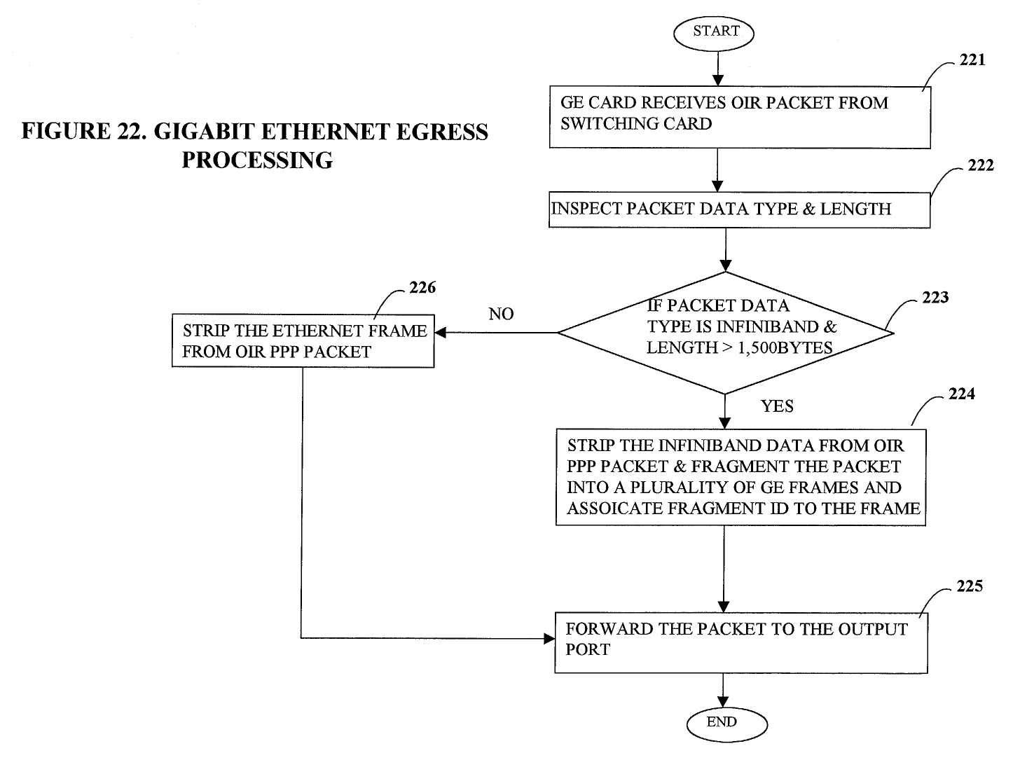

FIG. 21 illustrates the method of how Gigabit Ether-Channel Processing System 51 processes the input data, while FIG. 22 illustrates the method of how the said Gigabit Ether-Channel Processing System 51 processes the output data.

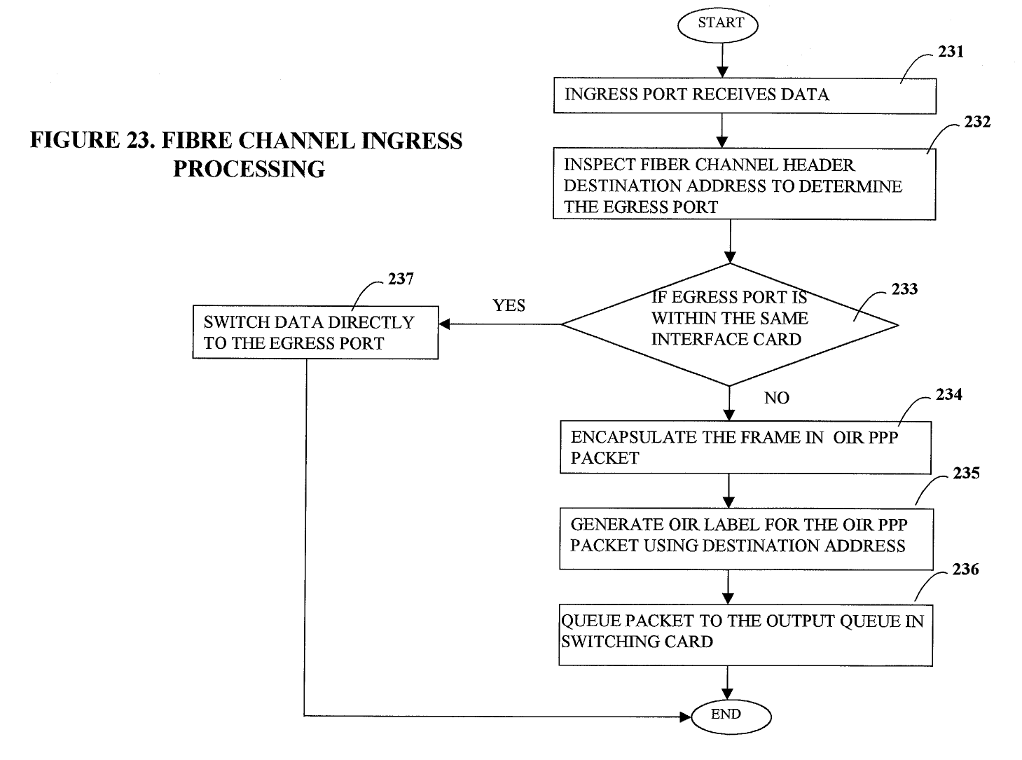

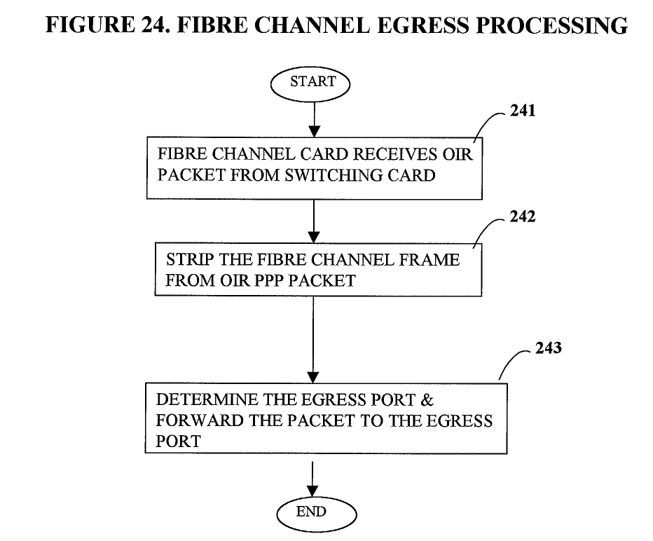

FIG. 23 illustrates the method of how Fibre Channel Processing System 56 processes the input data, while FIG. 24 illustrates the method of how the said Fibre Channel Processing System 56 processes the output data.

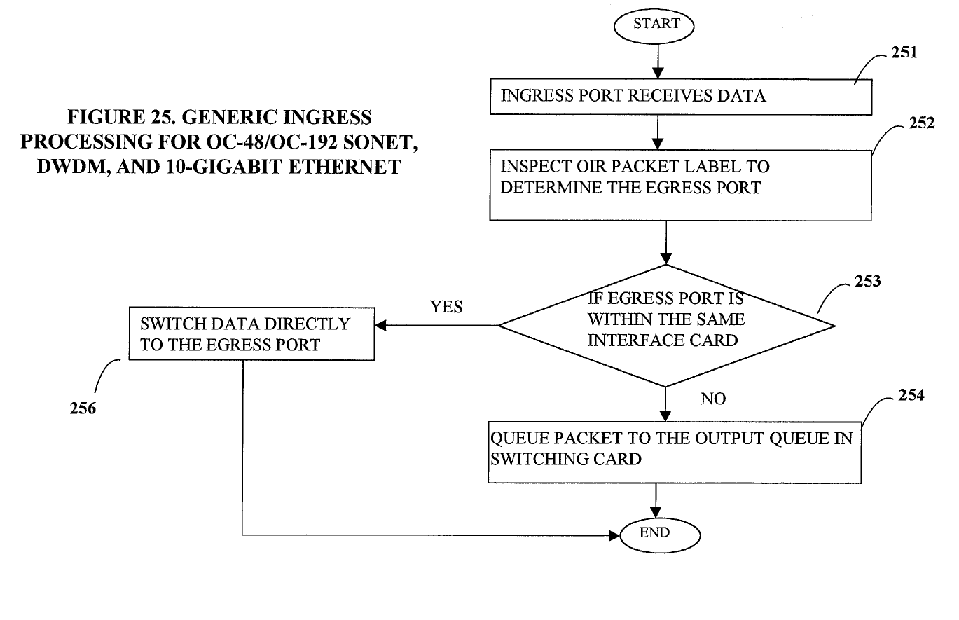

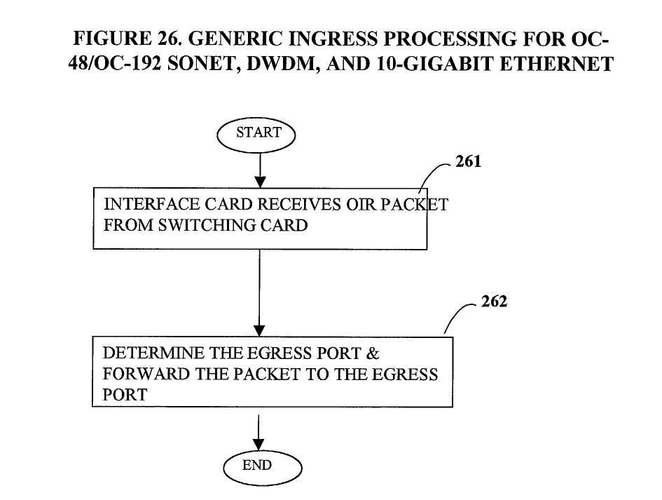

FIG. 25 illustrates the method of how Processing Systems for OC-48 SONET interface, OC-192 SONET interface, DWDM interface, and 10-Gigabit Ethernet interface 53, 57, 54, 52 process the input data, while FIG. 26 illustrates the method of how the said Processing Systems 53, 57, 54, 52 process the output data.

### CONCLUSION, RAMIFICATIONS, AND SCOPE

In addition to the combined InfiniBand switching and routing functions, the OIR system provides system and network multi-services for the following areas:

InfiniBand packets over Gigabit Ethernet Channels (Ether-Channel) for inter-subnet routing

InfiniBand packets over Ether-Channels and SONET for inter-network routing

InfiniBand packets over Multi-Wavelength DWDM for WAN-based inter-domain routing/transport

InfiniBand packets to Storage Area Network gateway (Fibre Channel gateway) function

InfiniBand packets to Network Attached Storage gateway (iSCSI gateway) function

Full InfiniBand Network Domain Management

InfiniBand Quality of Service (QoS)/Bandwidth control to Optical Network QoS/Bandwidth control mapping functions

This invention takes advantages of the InfiniBand architecture, extending it to incorporate the InfiniBand capabilities to go beyond the local area network. By using the optical networking capabilities, it allows processing modules and I/O modules to be connected through the local network, through the metro area network, and even to the wide area network.

In addition to the multi-services support functions, the OIR also include the following features to provide a highly reliable infrastructure:

Fully NEBS-compliant hardware platform

Interchangeable line card modules

Non-blocking, redundant switching fabric ensures highest service quality

Support for multiple access and transport types, including InfiniBand, Gigabit Ethernet, SONET, DWDM

Full 1+1 redundancy protects management processors and switching fabric modules

Hot-swappable components and support for online software and firmware upgrades offer the highest availability

Remote management tools accommodate either conventional or next generation network management systems

Replaces multiple network elements by performing functions that include InfiniBand switching and routing, IP switching and routing, SAN/NAS gateway functions, and SONET/DWDM payload switching

This invention will be unique and easily differentiated from competitive products because of its comprehensive service management solution, including network, system, and application levels management. It offers the simplicity of Ethernet technology, combined with the reliability and performance of the optical technology. It allows the customers to tune the system to deliver scalable, guaranteed rate access to multiple network services. This will give our customer the important time-to-market and differentiated service advantage they need to compete in the new networking market.

To the potential customer, the OIR is the natural choice given its multi-service nature, speed, and undisputed cost advantage. OIR also brings new dimensions of simplicity compare to earlier generation wide-area network (WAN) access technologies. It will become the service demarcation point for traffic in LAN, SAN, NAS, MAN, and WAN.

Multi-service access eliminates the incorporation of multiple networking transport switches/routers within a data center. Any service can be attached to the OIR without the complexity in managing the different characteristics of multi-vendor equipment.

Traffic is encapsulated into the OIR transport and groomed to high-speed SONET/SDH paths, or trunks, which ultimately terminates at the required Internet, native Ethernet, and/or InfiniBand-based service destination. Efficiency is assured with advanced bandwidth management capabilities plus the ability to share “trunks” among multiple customers and across multiple platforms

This invention simplifies the overall system network architecture by collapsing the capabilities of InfiniBand, IP switches and routers, SONET Add-Drop Multiplexers, and DWDM into one cost-effective and powerful optical router. Potential customers can select one or more service components that they want to use within our system. The service components can be interfaces for InfiniBand (2.5 gigabit or 10 gigabit), Gigabit Ethernet (3×1 gigabit or 10 gigabit), SONET (OC-48 or OC-192), or DWDM (4 channels OC-48 or 4 channels OC-192).

### BEST MODE FOR CARRYING OUT THE INVENTION

The problems solved by this invention is:

how to extend the System-Area Networking of the InfiniBand technology beyond the limited distance. The current specification defines the fiber connection distance to be less than 100 meters.

how to transport and route data between InfiniBand devices using the Gigabit Ethernet-based data transport.

how to combine a plurality of Gigabit Ethernet data streams into one InfiniBand data stream.

how to segment data between InfiniBand devices and the Gigabit Ethernet-based devices

how to transport and route data between InfiniBand devices using the SONET Add-Drop Multiplexing data transport.

how to transport and route data between InfiniBand devices using the Dense Wavelength Division Multiplexing (DWDM) data transport.

how to transport and route data between Fibre Channel devices using the Dense Wavelength Division Multiplexing (DWDM) data transport.

Operationally, one uses the Optical InfiniBand routing device to transport data from InfiniBand host or target devices through the OIR network to the destination InfiniBand host or target devices.

One can also use the OIR routing device to transport IP data, Fibre Channel data, or SCSI data through the OIR device to the destination devices. The OIR device has the capabilities to encapsulate any data and transport or route them to destinations that are supported by the OIR device.

When one uses the Gigabit Ethernet interface as the backbone transport, data such as InfiniBand, IP, Fibre Channel, and SCSI, are encapsulated into an OIR generic packet and passed down to the Gigabit Ethernet Media Access Layer (MAC) for data transport. When the data packet arrives at the destination, the data packet is stripped out from the Gigabit Ethernet Frame. The data packet header is inspected to determine the processing required. The raw data will be stripped from the data packet and forwarded to the destination interface.

Similar processing is done when one uses the SONET interface as the backbone transport, data such as InfiniBand, IP, Fibre Channel, and SCSI, are encapsulated into an OIR generic packet and passed down to the SONET framing processor for data transport. When the data packet arrives at the destination, the data packet is stripped out from the SONET Frame. The data packet header is inspected to determine the processing required. The raw data will be stripped from the data packet and forwarded to the destination interface.

When one uses the DWDM interface as the backbone transport, data such as InfiniBand, IP, Fibre Channel, and SCSI, are encapsulated into an OIR generic packet and passed down to the DWDM processor for data transport. When the data packet arrives at the destination, the data packet is stripped out from the DWDM payload. The data packet header is inspected to determine the processing required. The raw data will be stripped from the data packet and forwarded to the destination interface.

### ADVANTAGES OVER THE PRIOR ART

Accordingly, besides the objects and advantages of supporting multiple networking/system services described in my above patent, several objects and advantages of the present invention are:

to provide a system which can extend the transport of InfiniBand from the 100-meter limit to beyond 100 K meters

to provide a system which can transport InfiniBand data through Gigabit Ethernet interface between the InfiniBand host or target channel devices.

to provide a system which can transport InfiniBand data through the SONET Add-Drop Multiplexer interface between the InfiniBand host or target channel devices.

to provide a system which can transport InfiniBand data through the DWDM interface between the InfiniBand host or target channel devices.

to provide a system which can provide a gateway function, which can transport InfiniBand data streams to/from Network Attached Storage Filer devices.

to provide a system which can provide Quality of Service control over the InfiniBand data streams through the OIR network. The OIR network can be comprised of Gigabit Ethernet interfaces, SONET interfaces, Fibre Channel interfaces and DWDM interfaces.

Further objects and advantages are to provide a highly reliable, highly available, and highly scalable system, which can be upgradeable to different transport services, including Gigabit Ethernet, SONET, and DWDM. The system is simple to use and inexpensive to manufacture compared to the current Gigabit Ethernet-based IP routers, SONET Add-Drop Multiplexers, and DWDM devices. Still further objects and advantages will become apparent from a consideration of the ensuing description and drawings.

### OPERATION OF INVENTION

The manner in which the OIR system will be used is as follows:

to connect the InfiniBand Target Channel Adapter (TCA) optical cables or Host Channel Adapter (HCA) optical cables to the OIR InfiniBand optical port on an InfiniBand interface card. A plurality of TCA and HCA can be connected to the OIR InfiniBand optical port. In addition, a plurality of OIR InfiniBand interface card can be added to support additional connections. Upon connection, InfiniBand data streams can be transferred between the TCA and HCA devices.

to connect the Gigabit Ethernet (GE) optical cables to the OIR InfiniBand optical port on Gigabit Ethernet interface card. A plurality of Gigabit Ethernet networking devices can be connected to the OIR InfiniBand optical port. In addition, a plurality of OIR GE interface card can be added to support additional connections. Upon connection, Ethernet data streams can be transferred between the Ethernet devices. Currently, Gigabit Ethernet networking devices, other than the OIR system, carries only IP packets. In this situation, the OIR system will act as a high-speed IP router.

to connect the Gigabit Ethernet (GE) optical cables to the OIR InfiniBand optical port on Gigabit Ethernet interface card. A plurality of OIR systems can be connected to the OIR GE optical port. In addition, a plurality of OIR GE interface card can be added to support additional connections. Upon connection, OIR data packets can be transferred between the OIR systems. In this situation, the OIR system will act as a high-speed router for a plurality of data traffic, including InfiniBand, IP, Fibre Channel, and SCSI.

to connect the SONET optical cables to the OIR InfiniBand optical port on SONET interface card. A plurality of OIR systems or SONET Add-Drop Multiplexers can be connected to the OIR SONET optical port. In addition, a plurality of OIR SONET interface card can be added to support additional connections. Upon connection, OIR data packets can be transferred between the OIR system and SONET Add-Drop Multiplexing devices. In this situation, the OIR system will act as a high-speed SONET transporter for a plurality of data traffic, including InfiniBand, IP, Fibre Channel, and SCSI.

to connect the DWDM optical cables to the OIR DWDM optical port on DWDM interface card. A plurality of OIR systems or DWDM can be connected to the OIR SONET optical port. In addition, a plurality of OIR SONET interface cards can be added to support additional connections. Upon connection, OIR data packets can be transferred between the OIR system and DWDM devices. In this situation, the OIR system will act as a high-speed DWDM transporter for a plurality of data traffic, including InfiniBand, IP, Fibre Channel, and SCSI.

I claim:

1] A system comprises of a plurality of network interface devices, having the capabilities to route data from one network interface device to a plurality of network interface devices within the same said system, wherein the said system comprises:
A plurality of management devices;
A plurality of switching fabric devices;
A plurality of network interface devices that can encapsulate respective network interface protocol data into a common data packet that is used to route amongst the network interface devices within the said system;
Route means for forwarding a data packet from the source network device to destination network device; or from the source network device to a destination intermediate said system within a networked environment.

2] A system according to claim 1, wherein the source network device is an InfiniBand device, the data sent to the said optical device is InfiniBand frames, and the said system can forward the InfiniBand frames to the destination network device that is a InfiniBand device.

3] A system according to claim 1, wherein the source network device is a Fiber Channel device, the data sent to the said optical device is Fibre Channel frames, and the said system can forward the Fibre Channel frames to the destined network device that is a Fibre channel device.

4] A system according to claim 1, wherein the source network device is a Gigabit Ethernet device, the data sent to the said optical device is Ethernet frames, and the said system can forward the Ethernet frames to the destined network device that is an Ethernet device.

5] A system according to claim 1, wherein the source network device is an InfiniBand device, the data sent to the said optical device is InfiniBand frames, and the said system can forward the InfiniBand frames to the destination network device that is a Fibre Channel device.

6] A system according to claim 1, wherein the source network device is a Gigabit Ethernet device using IP protocol, the data sent to the said optical device is SCSI command encapsulated within IP packets, and the said system can forward the IP packet to the destination network device that is a iSCSI device.

7] A plurality of said system according to claim 1 connected together to form a system network, wherein the network interface used by the said system within the said network is InfiniBand; and wherein the said system can route the data according to claim 2 from the source network device to the destined network device through the said system network.

8] A plurality of said system according to claim 1 connected together to form a system network, wherein the network interface used by the said system within the said network is Gigabit Ethernet; and wherein the said system can route the data according to claim 2, claim 3, claim 4, claim 5 and claim 6 from the source network device to the destination network device through the said system network.

9] A plurality of said system according to claim 1 connected together to form a system network, wherein the network interface used by the said system within the said network is SONET; and wherein the said system can route the data according to claim 2, claim 3, claim 4, claim 5 and claim 6 from the source network device to the destination network device through the said system network.

10] A plurality of said system according to claim 1 connected together to form a system network, wherein the network interface used by the said system within the said network is DWDM; and wherein the said system can route the data according to claim 2, claim 3, claim 4, claim 5 and claim 6 from the source network device to the destination network device through the said system network.
